(19) United States
(12) Patent Application Publication
(10) Pub. No.: US 2004/0243429 A1
(43) Pub. Date: Dec. 2, 2004

(54) System and method for assigning undertakers for conducting cases handled by a professional office

(76) Inventors: Chung-I Lee, Tu-Chen (TW); Bao-Sheng Luo, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/856,104

(22) Filed: May 28, 2004

(30) Foreign Application Priority Data
May 28, 2003 (TW) 92114487

(51) Int. Cl. G06F 17/60

(52) U.S. Cl. 705/1

(57) ABSTRACT

A system for assigning undertakers for cases according to a preferred embodiment of present invention includes a database server (1) for storing relevant data, an application server (2), and a plurality of client computers (4) for users to access the application server via a communications network (3). The application server includes a plurality of software function modules for determining a type of a new case, formulating processing steps for the case, determining whether there are qualified undertakers available to perform each processing step, determining whether available qualified undertakers have time to perform corresponding processing steps, assigning at least one qualified undertaker to perform each processing step, generating an undertaker assignment sheet for the case, and tracking actual performance of the processing steps. A related method for assigning undertakers for a case is also provided.

### BACKGROUND OF THE INVENTION

1. Field of the invention

The present invention relates to systems and methods for electronic management of cases handled by professional offices, and especially to a system and method for electronic management of cases which can automatically assign undertakers for the cases.

2. Background of the invention

For professional offices, such as law offices and accounting firms, efficient case management is very important. The efficiency of managing cases directly affects actual completion times and the quality of results of the cases. Traditionally, most procedures of case management are handled manually. Manual procedures are generally time-consuming, and the corresponding labor costs can be high. For example, case managers may have to spend much time in querying historical case records, in order to assign suitable personnel to process a new case. The case managers may also need to spend time formulating processing steps for the new case, in order to ensure that the new case can be completed before a predetermined deadline.

With the recent development of computer science and network technology, case management methods based on a network such as an intranet are becoming more and more popular in professional offices because of their relatively simple processes, lower error rates, and lower costs. The art of case management through utilizing computers and networks is disclosed in patents such as U.S. Pat. No. 6,098,070 issued on Aug. 1, 2000 and entitled Case Management for a Personal Injury Plaintiff's Law Office Using a Relational Database. This patent discloses a method for collecting and organizing case data in an efficient manner using a relational database.

However, the method disclosed in this patent does not address how to assign qualified personnel as undertakers to process cases. This can not only delay actual starting and completion times of cases, but can also lead to poor quality of results of the cases. What is needed is an efficient system and method for assigning suitable undertakers for cases which can overcome the above-described problems.

### SUMMARY OF THE INVENTION

Accordingly, a main objective of the present invention is to provide a system and method for assigning undertakers for new cases according to historical case records and basic data on the new cases.

To accomplish the above objective, a system for assigning undertakers for cases in accordance with a preferred embodiment of the present invention comprises: a database server for storing rules of case classification, historical case records, undertaker worksheets, and basic data on cases; an application server for determining a type of a new case, formulating processing steps for the case, determining whether there are qualified undertakers available to perform each processing step, determining whether available qualified undertakers have time to perform corresponding processing steps, assigning at least one qualified undertaker to perform each processing step, generating an undertaker assignment sheet for the case, and tracking actual performance of the processing steps; and a plurality of client computers connected to the application server via the network for providing interactive user interfaces to access the application server via a communications network.

Further, a method for assigning undertakers for a case according to the present invention comprises the following steps: (1) determining a type of a new case; (2) formulating processing steps for the case, and determining a type and a processing time for each processing step; (3) determining whether there are qualified undertakers available to perform each processing step; (4) determining whether available qualified undertakers have time to perform corresponding processing steps; (5) assigning at least one qualified undertaker for each processing step; (6) generating an undertaker assignment sheet for the case; and (7) tracking actual performance of the processing steps, and generating tracking records.

Other objects, advantages and novel features of the present invention will be drawn from the following detailed description of the preferred embodiment and preferred method of the present invention with the attached drawings, in which:

### BRIEF DESCRIPTION OF THE DRAWINGS

FIG. 1 is a schematic diagram of hardware configuration of the system for assigning undertakers for cases in accordance with the preferred embodiment of the present invention, the system comprising an application server and a database server;

FIG. 2A is a schematic diagram of main software function modules of the application server of the system of FIG. 1;

FIG. 2B is a schematic diagram of main software function sub-modules of an undertaker assigning module of the application server of FIG. 2.

FIG. 3 illustrates data flow among the function modules of the application server of FIG. 2, and also data flow between the function modules and the database server of the system of FIG. 1;

FIG. 4 illustrates main fields of an exemplary undertaker worksheet in accordance with the present invention;

FIG. 5 is a flowchart of a preferred method for assigning undertakers for a case in accordance with the present invention, utilizing the system of FIG. 1; and

FIG. 6 is a flowchart of details of implementing one step of FIG. 5, namely assigning at least one qualified undertaker for each processing step of the case.

### DETAILED DESCRIPTION OF THE INVENTION

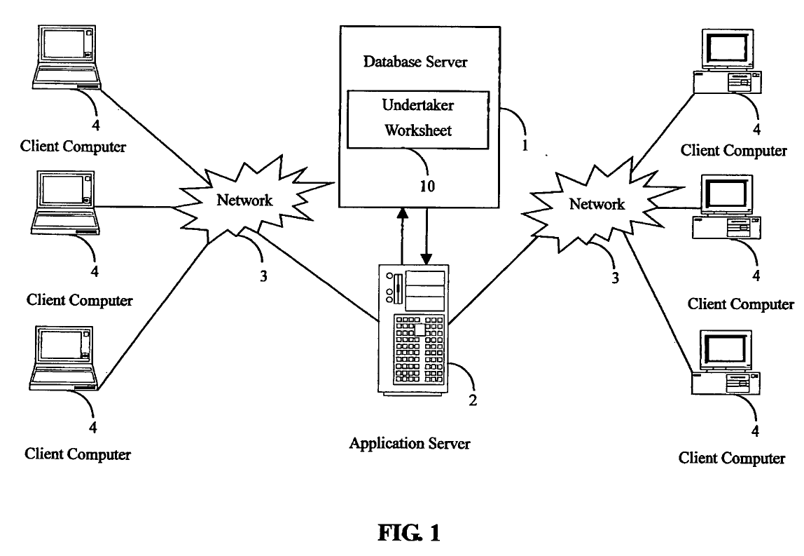

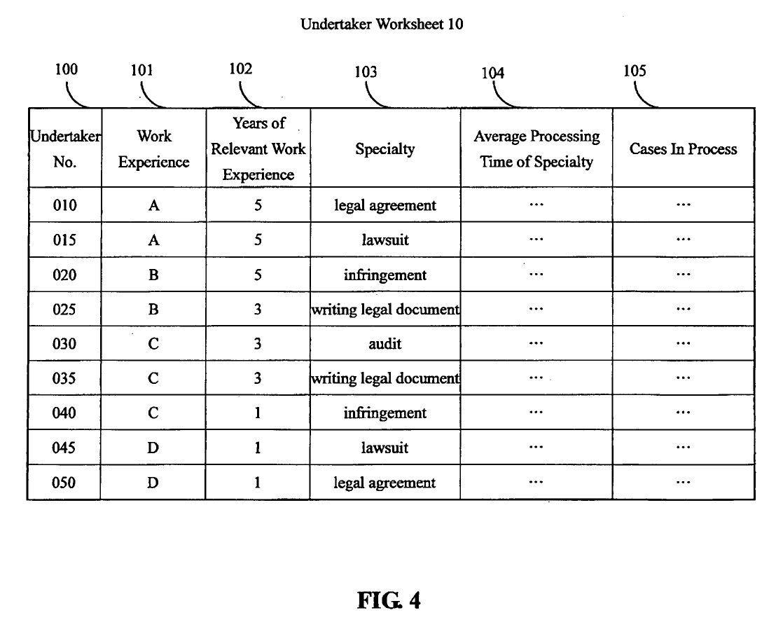

FIG. 1 is a schematic diagram of hardware configuration of a system for assigning undertakers for conducting cases handled by a professional office (hereinafter, “the system”) in accordance with the preferred embodiment of the present invention. The system comprises a database server 1, an application server 2, and a plurality of client computers 4. The database server 1 is used for storing data such as rules of case classification, historical case records, undertaker worksheets 10, and basic data on cases. The application server 2 is for determining which type of case a new case is, formulating processing steps for the case, determining whether there are qualified undertakers available to perform each processing step, determining whether available qualified undertakers have time to perform corresponding processing steps, generating an undertaker assignment sheet, and tracking actual performance of the processing steps of the case. In this description, a “type” of a case refers to a classification of the case, and an “undertaker” of a case refers to a person charged with handling a processing step of the case. The client computers 4 are connected with the application server 2 via a network 3. Each client computer 4 provides an interactive user interface for users to access the application server 2. The undertaker worksheets 10 are stored in the database server 1, and record processing statuses of all cases for each undertaker. Each undertaker worksheet 10 includes fields for: undertaker no., work experience, specialty, average processing time of specialty, etc. The undertaker worksheet 10 is described in more detail below in relation to FIG. 4.

The rules of case classification stored in the database server 1 enable users to determine which type of case a new case is, and determine which historical cases are similar to the new case. The historical case records stored in the database server 1 are used for recording relevant data on all completed cases. Each historical case record includes a general description, a case type, and processing steps of a corresponding historical case. Data on processing steps of a historical case include a type of each processing step, undertakers of each processing step, actual processing time, completion time, etc. In this description, a “type” of a processing step refers to a classification of the processing step.

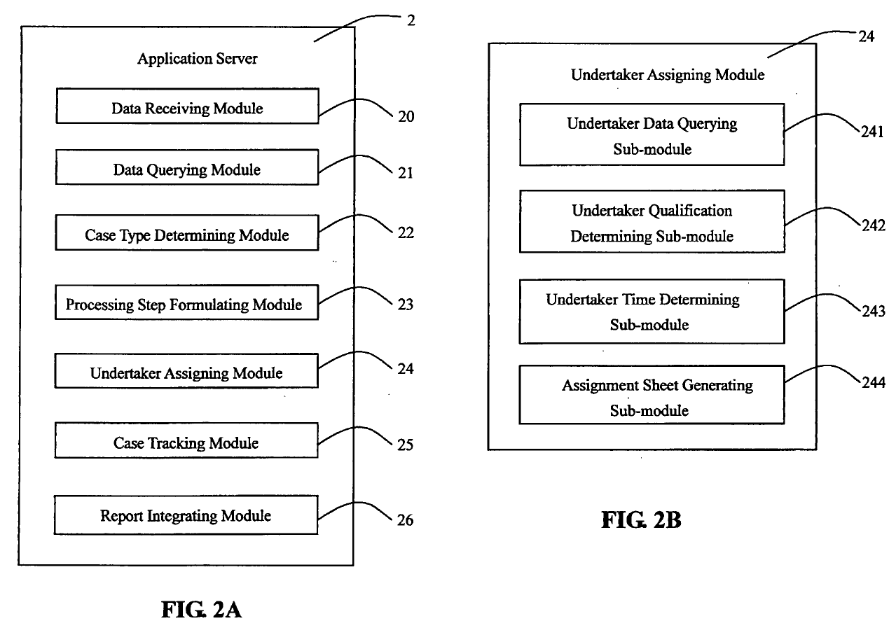

FIG. 2A is a schematic diagram of main software function modules of the application server 2. The application server 2 comprises a data receiving module 20, a data querying module 21, a case type determining module 22, a processing step formulating module 23, an undertaker assigning module 24, a case tracking module 25, and a report integrating module 26.

The data receiving module 20 is used for receiving basic data on a new case from any one client computer 4, and storing the basic data on the case in the database server 1. The data querying module 21 is connected with the database server 1, and is for querying rules of case classification, historical case records and undertaker worksheets 10 according to the basic data on the case stored in the database server 1. The case type determining module 22 is for determining a type of the case in accordance with the rules of case classification provided by the data querying module 21. The processing step formulating module 23 is used for formulating processing steps for the case, determining a type and a processing time for each processing step, and generating processing step data on the case according to the historical case records and the type of the case. The processing step data on the case include a type of each processing step and a standard processing time for each processing step.

The undertaker assigning module 24 is for assigning at least one undertaker for each processing step of the case according to a corresponding undertaker worksheet 10 and the processing step data on the case. The case tracking module 25 is used for tracking actual performance of the processing steps of the case, and generating case tracking records. That is, the case tracking module 25 records a finish time and a corresponding undertaker for each processing step of the case. The report integrating module 26 is for modifying the undertaker worksheet 10 according to the case tracking records.

FIG. 2B is a schematic diagram of main software function sub-modules of the undertaker assigning module 24. The undertaker assigning module 24 comprises an undertaker data querying sub-module 241, an undertaker qualification determining sub-module 242, an undertaker time determining sub-module 243, and an assignment sheet generating sub-module 244.

The undertaker data querying sub-module 241 is for querying any undertaker worksheet 10 and rules of case classification in the database server 1. The undertaker qualification determining module 242 is used for determining whether there are qualified undertakers available to perform each processing step of the case according to the processing step data on the case generated by the processing step formulating module 23 and the undertaker worksheet 10.

The undertaker time determining sub-module 243 is for determining whether available qualified undertakers have time to perform corresponding processing steps, and for assigning at least one qualified undertaker to perform each processing step. The assignment sheet generating sub-module 244 is for generating an undertaker assignment sheet for the case according to assignment results.

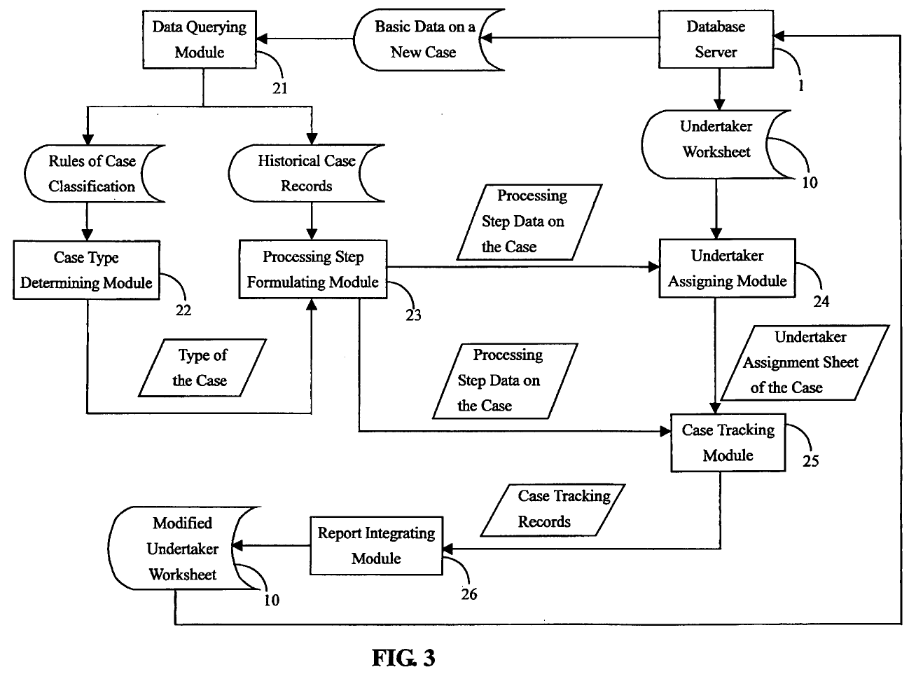

FIG. 3 illustrates data flow among the function modules of the application server 2, and also data flow between the function modules and the database server 1. The data querying module 21 obtains basic data on a new case from the database server 1, queries rules of case classification from the database server 1 according to the basic data on the case, and transmits the rules of case classification to the case type determining module 22. The case type determining module 22 analyzes the rules of case classification, determines a type of the case, and transmits the type of the case to the processing step formulating module 23. The data querying module 21 also queries historical case records stored in the database server 1, and transmits the historical case records to the processing step formulating module 23.

The processing step formulating module 23 formulates processing steps for the case, determines a type and a processing time for each processing step, generates processing step data on the case according to the historical case records and the type of the case, and transmits the processing step data on the case to the undertaker assigning module 24 and the case tracking module 25. The undertaker assigning module 24 assigns at least one undertaker for each processing step according to the processing step data on the case, and according to an undertaker worksheet 10 obtained from the database server 1. The undertaker assigning module 24 thus generates an undertaker assignment sheet of the case, and transmits the undertaker assignment sheet of the case to the case tracking module 25.

The case tracking module 25 tracks the actual performance of processing steps of the case, generates case tracking records in accordance with the processing step data on the case and the undertaker assignment sheet of the case, and transmits the case tracking records to the report integrating module 26. The report integrating module 26 modifies the undertaker worksheet 10 according to the case tracking records, and stores the modified undertaker worksheet 10 in the database server 1.

FIG. 4 illustrates main fields of an exemplary undertaker worksheet 10 in accordance with the present invention. The undertaker worksheet 10 records processing statuses of cases for each undertaker, and provides for assigning of suitably qualified undertakers to new cases. The undertaker worksheet 10 includes columns for: undertaker no. 100, work experience 101, years of relevant work experience 102, specialty 103, average processing time of specialty 104, and cases in process 105.

As indicated, work experience designated grade “A” means that a corresponding undertaker has abundant experience in processing a particular type of case. Work experience designated grade “D” means that a corresponding undertaker has poor experience in processing a particular type of case. The specialty 103 records a type of case that is the specialty of a corresponding undertaker. For example, the undertaker with undertaker no. 010 specializes in legal agreements. The undertaker with undertaker no. 035 specializes in writing legal documents. The average processing time of specialty 104 records average time needed for an undertaker to process a case of his/her specialty from beginning to end. The average processing time of specialty 104 can be used to determine whether the corresponding undertaker is likely to be able to complete a new case of his/her specialty before a predetermined deadline. The cases in process 105 records a number of cases presently being processed by each undertaker, and is used to determine whether an undertaker is likely to have time to process an extra new case.

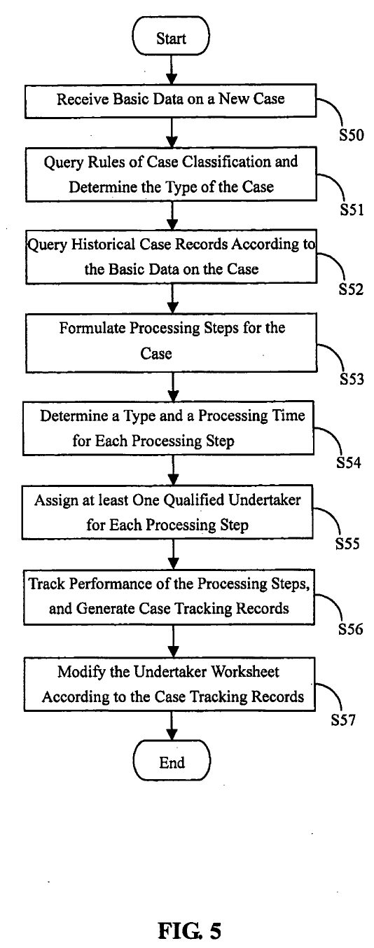

FIG. 5 is a flowchart of a preferred method for assigning undertakers for a case in accordance with the present invention, utilizing the system described above. In step S50, the data receiving module 20 receives basic data on a new case, and stores the basic data on the case in the database server 1. In step S51, the data querying module 21 queries the rules of case classification according to the basic data on the case stored in the database server 1. The case type determining module 22 determines the type of the case according to the rules of case classification. In step S52, the data querying module 21 queries the historical case records in accordance with the basic data on the case. In step S53, the processing step formulating module 23 formulates processing steps for the case according to the historical case records and the type of the case.

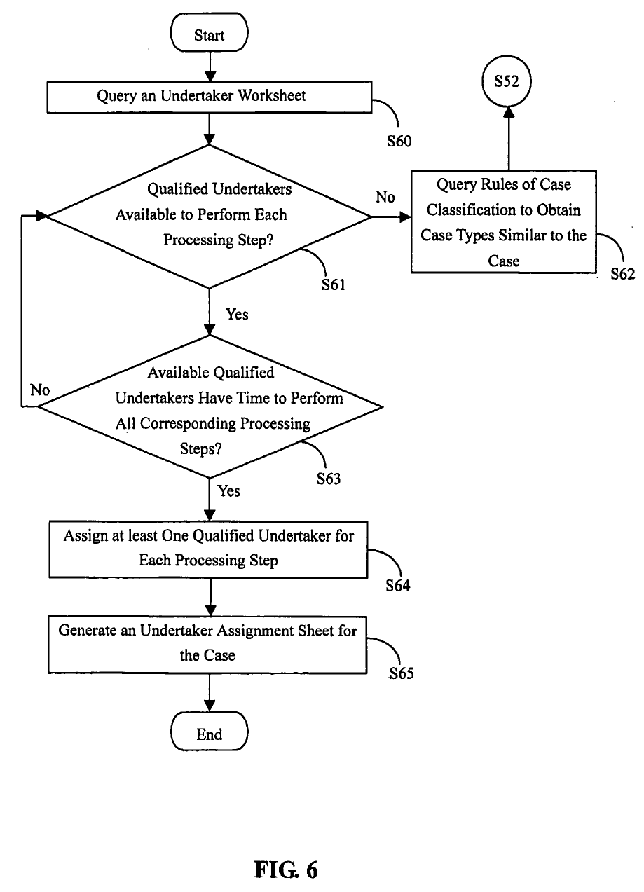

In step S54, the processing step formulating module 23 determines a type and a processing time for each processing step according to the historical case records and the type of the case, and generates processing step data on the case. In step S55, the undertaker assigning module 24 assigns at least one qualified undertaker for each processing step according to an undertaker worksheet 10 and the processing step data on the case, and generates an undertaker assignment sheet of the case. This step of the procedure is described in more detail below in relation to FIG. 6. In step S56, the case tracking module 25 tracks actual performance of the processing steps, and generates tracking records for the case according to the processing step data on the case and the undertaker assignment sheet of the case. In step S57, the report integrating module 26 modifies the undertaker worksheet 10 according to the case tracking records, and stores the modified undertaker worksheet 10 in the database server 1.

FIG. 6 is a flowchart of details of implementing step S55 of FIG 5, namely assigning at least one qualified undertaker for each processing step of the case. In step S60, the undertaker data querying sub-module 241 queries an undertaker worksheet 10 in the database server 1. In step S61, the undertaker qualification determining module 242 determines whether there are qualified undertakers available to perform each processing step according to the processing step data on the case generated by the processing step formulating module 23 and the undertaker worksheet 10. If there are qualified undertakers available to perform each processing step, the procedure goes directly to step S63 described below. If there are no qualified undertakers available to perform any processing step, in step S62, the undertaker data querying sub-module 241 queries rules of case classification in the database server 1 to obtain case types similar to the case, whereupon the procedure returns to step S52 described above in relation to FIG. 5.

In step S63, the time determining sub-module 242 determines whether available qualified undertakers have time to perform corresponding processing steps. If no qualified undertaker has time to perform a particular processing step, the procedure returns to step S61 in respect of that processing step. If and when available qualified undertakers have time to perform all the corresponding processing steps, in step S64, the undertaker assigning sub-module 243 assigns at least one qualified undertaker to perform each processing step. In step S65, the assignment sheet generating sub-module 244 generates an undertaker assignment sheet for the case according to assignment results.

Although the present invention has been specifically described on the basis of a preferred embodiment and preferred method, the invention is not to be construed as being limited thereto. Various changes or modifications may be made to said embodiment and method without departing from the scope and spirit of the invention.

What is claimed is:

1. A system for assigning undertakers for cases, comprising:
a database server for storing rules of case classification, historical case records, undertaker worksheets, and basic data on cases;
an application server comprising:
a case type determining module for determining a type of a new case;
a processing step formulating module for formulating processing steps of the case;
an undertaker assigning module for assigning undertakers for the case, comprising:
an undertaker data querying sub-module for querying an undertaker worksheet in the database server;
an undertaker qualification determining sub-module for determining whether there are qualified undertakers available to perform each processing step;
an undertaker time determining sub-module for determining whether available qualified undertakers have time to perform corresponding processing steps, and for assigning at least one qualified undertaker to perform each processing step; and
an assignment sheet generating sub-module for generating an undertaker assignment sheet for the case; and
a plurality of client computers for providing interactive user interfaces for users to access the application server via a communications network.

2. The system for assigning undertakers for cases as claimed in claim 1, wherein the application server further comprises a data receiving module for receiving basic data on the case and storing the basic data on the case in the database server.

3. The system for assigning undertakers for cases as claimed in claim 1, wherein the application server further comprises a data querying module for querying the rules of case classification, the historical case records, and the undertaker worksheets.

4. The system for assigning undertakers for cases as claimed in claim 1, wherein the application server further comprises a case tracking module for tracking actual performance of the processing steps, and generating case tracking records.

5. The system for assigning undertakers for cases as claimed in claim 1, wherein the application server further comprises a report integrating module for modifying the undertaker worksheets according to the case tracking records.

6. A computer-enabled method for assigning undertakers for a case, comprising the steps of:
determining a type of a new case according to rules of case classification;
formulating processing steps for the case, and determining a type and a processing time for each processing step;
querying an undertaker worksheet according to the types of the processing steps;
determining whether there are qualified undertakers available to perform each processing step;
determining whether available qualified undertakers have time to perform corresponding processing steps, if there are qualified undertakers available to perform each processing step;
assigning at least one qualified undertaker to perform each processing step, if the available qualified undertakers have time to perform the corresponding processing steps; and
generating an undertaker assignment sheet for the case.

7. The method for assigning undertakers for a case as claimed in claim 6, further comprising the step of tracking actual performance of the processing steps, and generating case tracking records.

8. The method for assigning undertakers for a case as claimed in claim 7, further comprising the step of modifying an undertaker worksheet according the case tracking records.

9. The method for assigning undertakers for a case as claimed in claim 6, wherein the step of determining whether there are qualified undertakers available to perform each processing step comprises the step of:
querying rules of case classification to obtain case types similar to the case, if there are no qualified undertakers available to perform any processing step.

10. The method for assigning undertakers for a case as claimed in claim 6, wherein the step of determining whether available qualified undertakers have time to perform corresponding processing steps comprises the step of:
determining whether there is another qualified undertaker available to perform a particular processing step, if no available qualified undertaker has time to perform that particular processing step.
